(19) United States
(12) Patent Application Publication
(10) Pub. No.: US 2010/0230410 A1
(43) Pub. Date: Sep. 16, 2010

(54) Twist Cap Closure Assembly

(75) Inventors: Laurens Last, Monaco (MC); Peter-Jan Van Der Molen, Den Haag (NL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: IPN IP B.V., Houten (NL)

(21) Appl. No.: 12/294,443

(22) PCT Filed: Apr. 3, 2007
(86) PCT No.: PCT/NL2007/000093

§ 371 Date: Feb. 24, 2009

(30) Foreign Application Priority Data
Apr. 3, 2006 (NL) PCT/NL2006/000169

(51) Int. Cl. B65D 51/22; B23P 11/00

(52) U.S. Cl. 220/258.4; 220/259.3; 29/428

(57) ABSTRACT

A twist cap closure assembly comprising: an injection moulded thermoplastic base (1) including a tubular part, which has an interior side defining a channel in said tubular part and also has an exterior side, said tubular part forming a mouth of said channel at one end thereof, an injection moulded thermoplastic twist cap (50) adapted to be fitted on said tubular part of said base so as to close off the mouth in a closed position of said cap, said cap including a top wall and a downward skirt depending from said top wall, said skirt having an interior side, an exterior side and a lower edge, said exterior side of said tubular part and said interior side of said skirt having mating bayonet connector members, said bayonet connector members being adapted to hold said cap (50) in its closed position on said tubular part and allow for the cap to be twisted about a twist axis to release said cap (1) from the base so that the channel is opened, wherein a plug (70) is arranged within said tubular part of the base, said plug being injection moulded integrally with said base and forming a hermetic closure of said channel.

The present invention relates to a twist cap closure assembly.

A twist cap closure assembly is often designed to be used in combination with a container filled with a substance, e.g. for consumer use. The base of the assembly can be adapted to be fastened on the container, e.g. by a suitable (heat) sealing technique, glue (hotmelt), or otherwise, e.g. using a screwthreaded collar. It is for instance known to provide the base with a planar flange, often extending in a plane normal to the twist axis of the assembly. This flange can for instance be welded onto a plastic container or for instance a container of plastic coated cardboard. Also the base could be adapted for mounting between opposed walls of a flexible pouch, e.g. the base having a boat or eye shaped part to be fitted between said walls.

By twisting the cap, e.g. over 360 or 180 degrees or another twist angle range less than a full turn the cap is released from the base.

The need exists to provide closure assemblies having improved closure or protection properties, thereby providing a reliable guarantee that the content of the container is shielded from the atmosphere. In particular nowadays aseptic requirements are often imposed on closure assemblies.

Closure assemblies have been proposed that provide an additional barrier within the tubular member closing off the channel hermetically. This barrier is then ruptured upon opening of the closure assembly by twisting the cap.

The present invention is based on the insight that these known assemblies do not provide a satisfactory solution. A drawback of the known closure assemblies designed with said additional barrier is for instance that they are awkward and/or unreliable to operate, e.g. for a consumer. Another drawback is that they are known to show undesirable pouring behaviour during discharge of the contents from the container. Also these known closure assemblies are undesirably complex, hardly suitable for mass production, and as a result too expensive.

It is an object of the present inventive to provide an improved twist cap closure assembly, preferably embodied so as to overcome one or more of the above-mentioned drawbacks.

It is a further object of the present inventive to provide an alternative twist cap closure assembly.

The present invention proposes a twist cap closure assembly according to claim 1. A plug is present within said tubular part of the base, said plug being injection moulded integrally with said base and forming a hermetic closure of the channel in the tubular part.

The plug is integrally connected to said interior side of the tubular part at a location spaced from said mouth. A circular frangible section is formed when injection moulding said base with integral plug.

The plug and the cap include mating plug-cap connector members that are integrally moulded with said plug and cap respectively, said plug-cap connector members being adapted to cause said plug to be connected to said cap in the course of first-time fitting of said cap on said tubular part in its closed position.

The plug-cap connector members also form a rotary connection allowing for rotation of said cap with respect to the plug when the cap is twisted from its closed position to release the cap from the base.

The plug-cap connector members furthermore are adapted to retain said plug in said cap when said cap is twisted in opening direction and released from the base.

The cap further includes one or more force members depending from said top wall so as to extent towards the plug when the cap is in its closed position, said one or more force members engaging on said plug upon twisting open said cap, said force members thereby exerting a force on said plug causing said circular frangible section to rupture (at least partly) allowing the release of said plug along with the cap from said base.

The twist cap closure assembly according to the invention can be manufactured without undesirable complexity. Operation by e.g. a consumer is straightforward and can be effected without any additional operation other than twisting the cap from its closed in its opening direction. The plug is retained in the cap upon opening the closure and releasing the cap from the base. In a preferred embodiment the plug is retained within the cap such that basically the consumer does not even notice the plug being retained in the cap.

The circular frangible section is adjacent the interior side of the channel, so that the entire channel is available for the flow of substance after removal of the plug and suitably designed such that no impairment of the flow results at the original location of the plug.

Preferred details of the closure assembly according to the invention as well as alternative designs are described in the appended claims and in the description referring to the drawings.

The present invention further relates to a container provided with such a twist cap closure assembly and the manufacturing of the twist cap closure assembly.

The present invention also relates to a closure assembly as shown in the appended drawings.

The twist cap closure assembly can be used for all sorts of applications, including e.g. (carton) packages for beverages, food products (e.g. dairy products) or other consumer products, e.g. hair care, body care, etc, as well as e.g. medical or pharmaceutical applications, e.g. such as infusion bottles or bags, etc.

In the drawings:

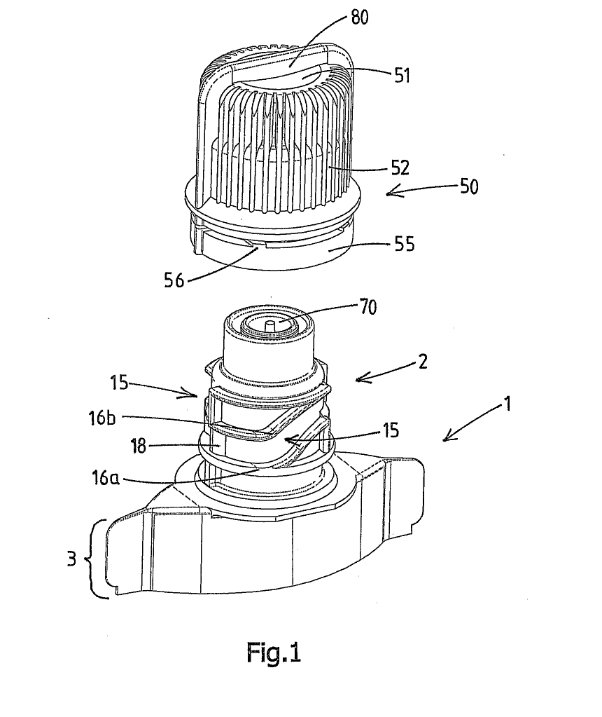

FIG. 1 shows a first preferred embodiment of a twist cap closure assembly according to the invention prior to snap fitting the cap onto the tubular part of the base,

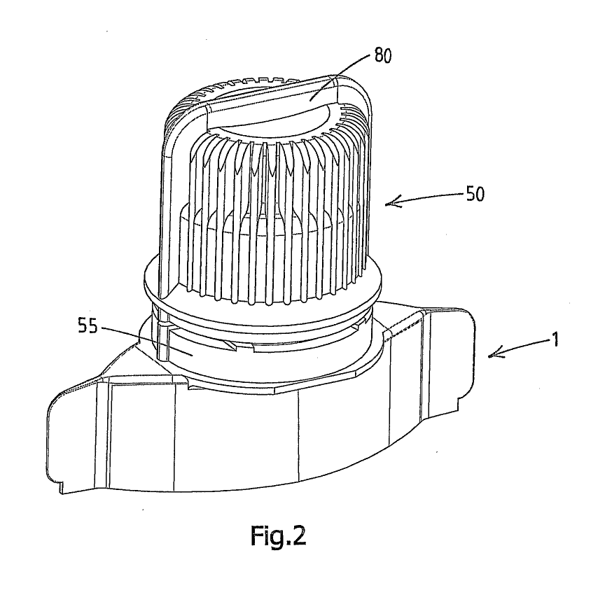

FIG. 2 shows the embodiment of FIG. 1 in closed state,

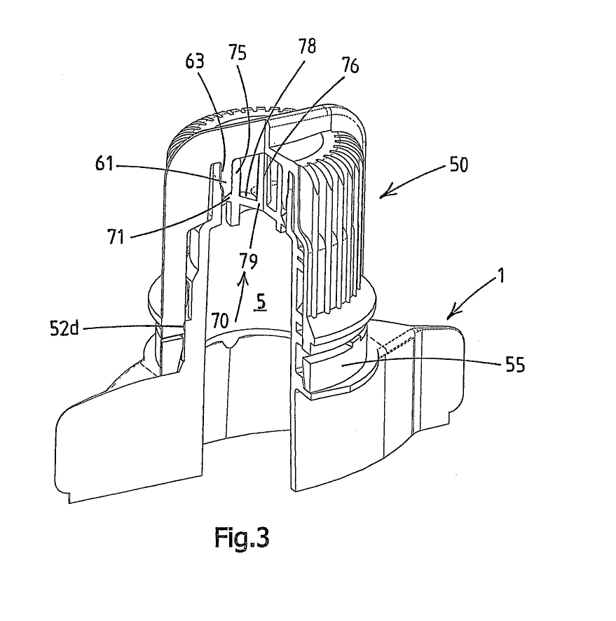

FIG. 3 shows the embodiment of FIG. 1 in closed state, partly in cross-section,

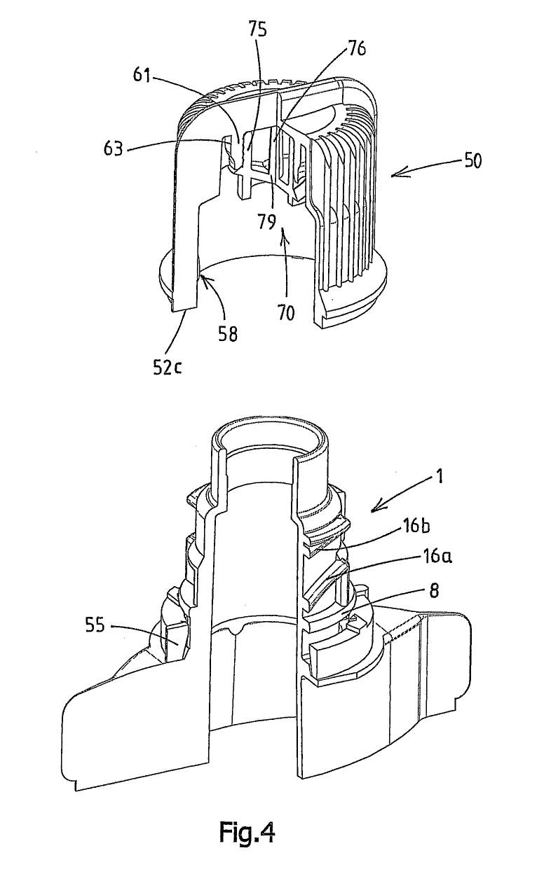

FIG. 4 shows the embodiment of FIG. 1 after opening, partly in cross-section,

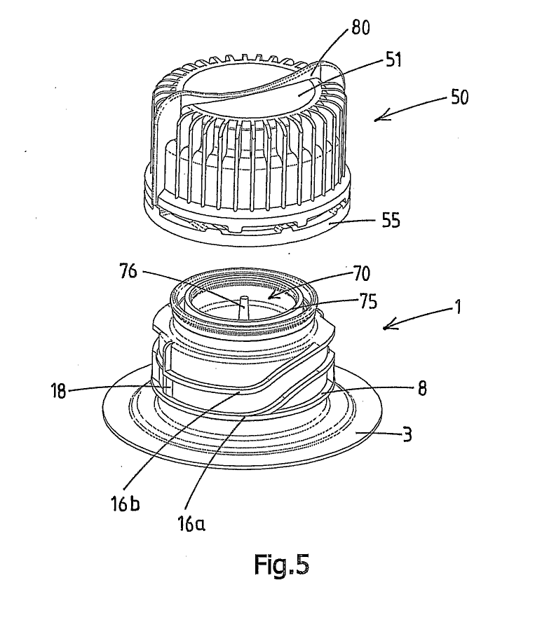

FIG. 5 shows a second embodiment of a twist cap closure assembly according to the invention prior to snap fitting the cap onto the tubular part of the base,

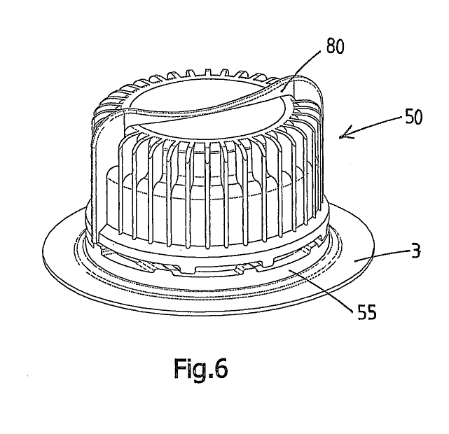

FIG. 6 the second embodiment in closed state,

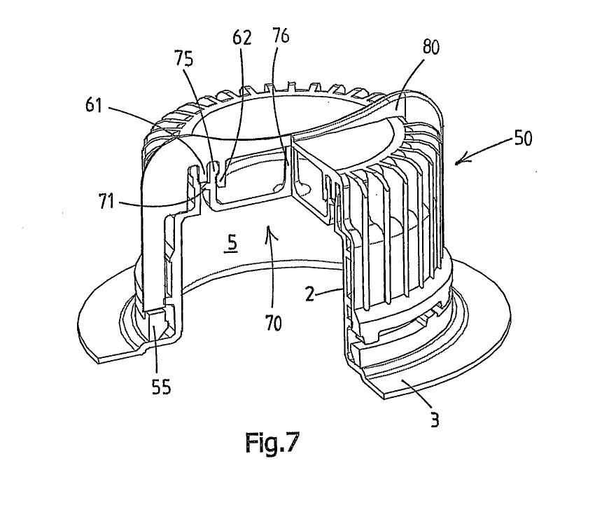

FIG. 7 the second embodiment in closed state, partly in cross-section,

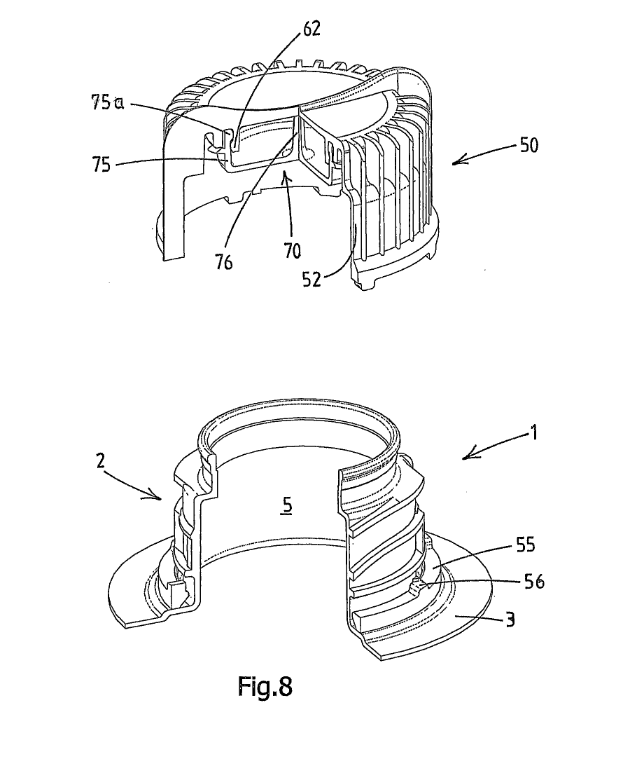

FIG. 8 the second embodiment in opened state, partly in cross-section,

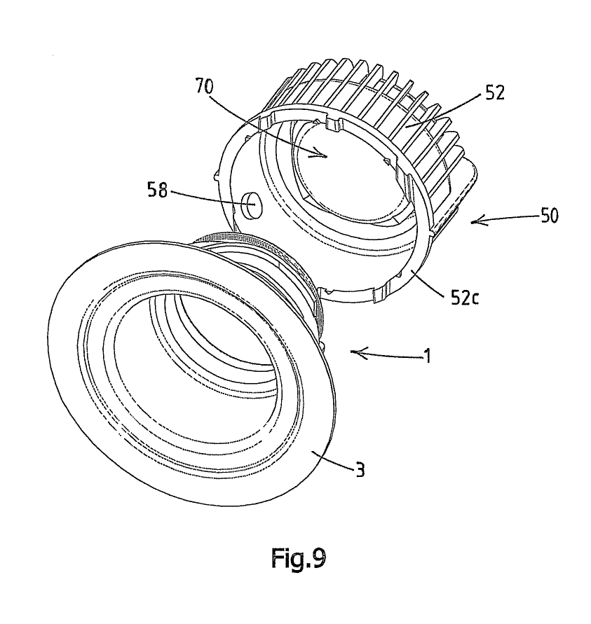

FIG. 9 the second embodiment in opened state from below,

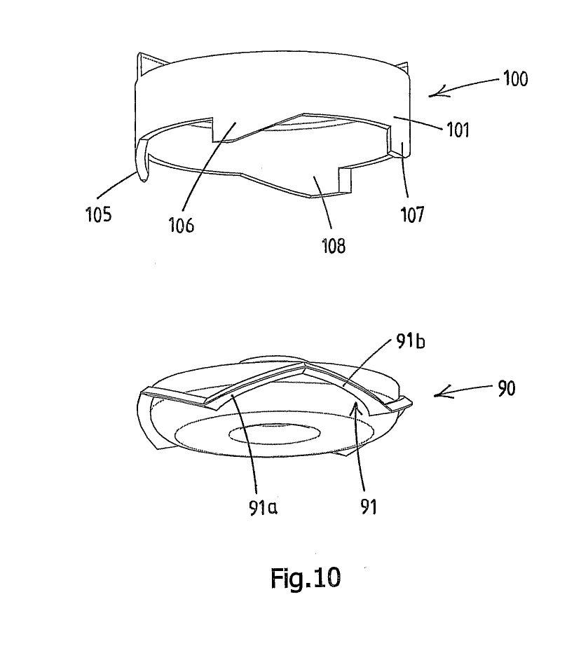

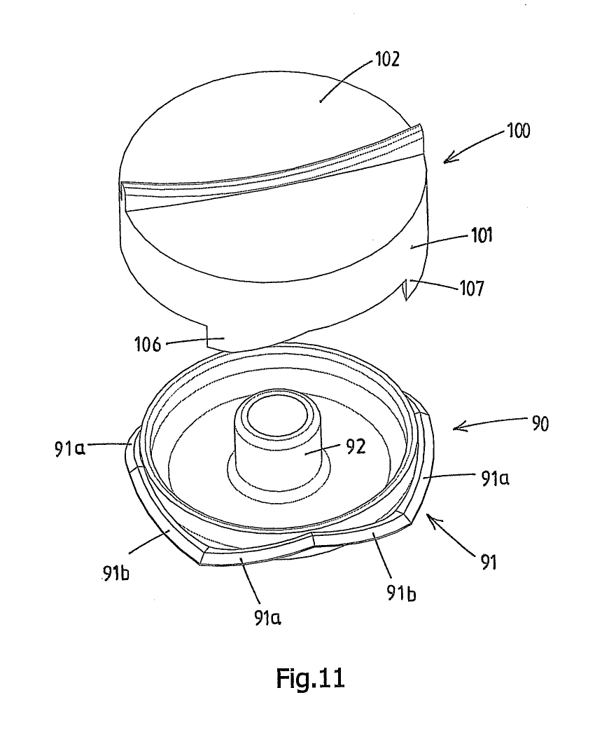

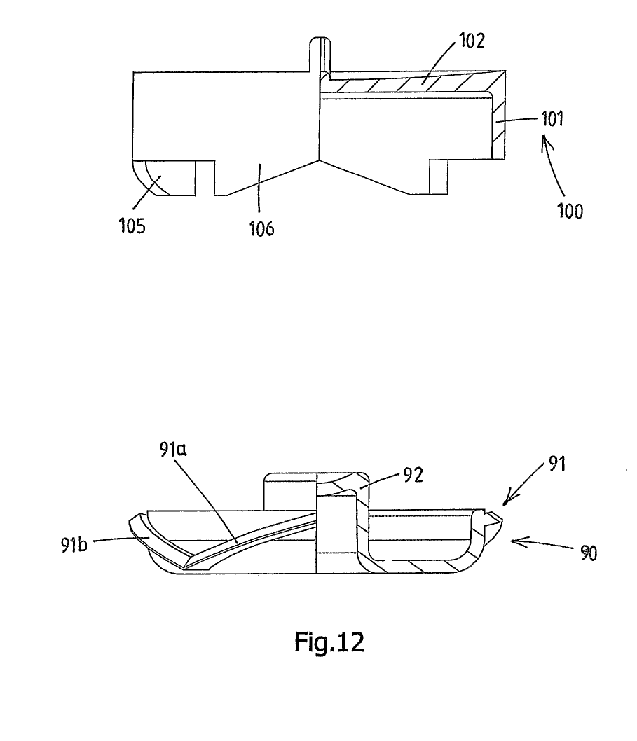

FIGS. 10-12 show a preferred embodiment of the force members and the frangible section for the twist cap closure assembly according to the invention.

First an embodiment of the inventive twist cap closure assembly according to FIGS. 1-4 will now be explained in detail.

The twist cap closure assembly is composed of, as is preferred, two parts namely a base 1 and a cap 50.

The base 1 here is a monolithic injection moulded thermoplastic base 1, which includes a tubular part, generally indicated with reference numeral 2, and a container part 3.

The container part 3 allows the base 1 to be fitted to a container, in this embodiment adapted for fitting between opposed walls of a pouch, e.g. of (multilayered) plastic film, here having a boat, eye or the like shape, which can be fastened to the walls, e.g. by a suitable (heat) sealing technique as is known in the art.

The skilled person will appreciate that many different designs of the container part 3 are possible, depending on the container to which the twist cap closure assembly has to fastened and/or the fastening technique to be employed. The container could even be of a tubular design, of have a tubular member to which the closure is fastened, e.g. of a diameter similar to the tubular part 2.

Extending through the base 1 and in particular through the tubular part 2 is a channel 5 which allows a substance to be dispensed from the pouch into which the assembly is integrated. The substance can be any substance, e.g. a liquid, a powder, a gas, a pasty substance, etc.

The channel 5 here is essentially defined by the interior side of the tubular part 2. The tubular part 2 also has an exterior side and forms a mouth of the channel 5 at the end remote from the container part 3. In this embodiment, as is preferred, the channel 5 is straight. The skilled person will appreciate that the tubular part can have a different design, e.g. an angled tubular part, etc.

The cap 50 is a monolithic injection moulded thermoplastic twist cap 50 and is adapted to be fitted on the tubular part 2 of the base 1 so as to close off the mouth in a closed position of the cap 50.

The cap 50 generally includes a top wall 51 and a downward skirt 52 depending from said top wall, said skirt 52 having an interior side, an exterior side and a lower edge 52c.

In FIGS. 1-4 it can be seen that the exemplary cap 50 further includes a tamper-evident band 55 formed as an integral part of the cap 50 during injection moulding of the cap 50 and arranged below the lower edge 52c of the skirt 52 and interconnected therewith, here through breakable bridges 56. The tamper-evident band 55 here has, as is known in the art, one or more parts (e.g. flexible lips) engaging under an associated surface arranged on the tubular member (here a circumferential lower rib 8 on the exterior of said tubular member).

The exterior side of the tubular part 2 and the interior side of the skirt 52 have mating bayonet connector members. Here the twist cap 50 is designed to be twisted open in about half a turn or 180 degrees rotation from its closed position in opening direction.

A ramp structure is provided on the exterior side of the tubular part 2. This ramp structure here includes two circumferentially spaced ramp arrangements 15, generally diametrical with respect to the tubular part 2. Each ramp arrangement 15 here includes an outwardly projecting lower rib 16a on the exterior of the tubular part 2 in this example. A further upper rib 16b is arranged spaced above the lower rib 16a and has a similar shape in circumferential direction. The design and effect of the ramp arrangements 15 will be explained in more detail below.

For each ramp arrangement 15 the cap 50 is on the interior of the skirt 52 provided with an associated lug or ramp follower 58, here at diametrically opposed locations (as can best be seen in FIG. 4). In the closed position of the cap 50 the lugs 58 each are located between the lower rib 16a and the upper rib 16b.

A stop rib 18, here essentially vertical between the upper and lower ribs 16a, b, is arranged on the exterior of the tubular part at one end, the closed state end, of the ramp arrangement 15. In the closed state of the assembly the lug 58 is intended to rest against or near said stop rib 18.

The cap 50 and the lugs 58 as well as the ribs 16a, b are designed so as to allow for the snap fitting of the cap 50 onto the tubular part, the lugs 58 traversing over the ribs 16b in the first-time fitting process of the cap 50 as will be explained below.

As can be seen best in FIG. 1 adjoining the rest location for the lug 58 defined by a stop rib 18 the ramp arrangement defines an essentially non-sloping section followed by a sloping lift section.

Upon twisting the cap 50 from its closed position, the cap 50 will first perform an essentially rotary motion about the tubular part 2, that is essentially without displacement in the longitudinal direction of the tubular part 2, as the lugs 58 each follow the non-sloping section of the ramp 15.

The lugs 58 then each arrive at the sloping section so that a combined rotary and lift motion of the cap 50 is caused, wherein the cap 50 both rotates and is lifted from the tubular part 2.

So the bayonet connector members are adapted to hold said cap 50 in its closed position on said tubular part 2 and to allow for the cap 50 to be twisted about a twist axis, here coinciding with the central axis of the tubular part 2, to release said cap 50 from the base 1 so that the channel 5 is opened.

It can be seen that in this example the non-sloping section here extends essentially over about a quarter turn, or 90 degrees, around the tubular part 2.

The base part 1 further includes a plug 70 which is arranged within the tubular part 2 of the base.

The plug 70 here is injection moulded integrally with the base 1 and forms a hermetic closure of said channel 5 as is shown in FIG. 3.

The plug 70 is integrally connected to the interior side of the tubular part 2 at a location spaced from the mouth and via a circular frangible section 71 formed by injection moulding said base 1 with integral plug 70.

The plug 70 and cap 50 include mating plug-cap connector members, which could also be named plug and cap connector members, integrally moulded with the plug and the cap. The plug-cap connector members are adapted to cause the plug 70 to be connected to the cap 50 in the course of first-time fitting of the cap 50 on the tubular part 2.

The plug-cap connector members also form a rotary connection allowing for rotation of the cap 50 with respect to the plug 70 when the cap 50 is twisted from its closed position in order to open and release the cap 50 from the base 1. Thus no rotary motion is transferred from the cap 50 to the base 1, at least not while the plug 70 is still held in the base 1 by the (mostly) intact frangible section 71.

The plug-cap connector members furthermore are adapted to retain said plug 70 in the cap 50 when the cap 50 is twisted and released from the base 1. This is in particular visible when comparing FIG. 1 (plug 70 present in upper end of tubular part) and FIG. 4 (plug 70 released from base and now present inside cap 50). FIG. 4 shows the plug 70 while being held inside the cap 50, essentially in the upper end thereof.

The cap 50 further includes a number of force members depending from the top wall 51 so as to extent towards the plug 70 when the cap is in its closed position. These force members engage on the plug 70 upon twisting open the cap 50, the force members thereby exerting a force on the plug 70 causing the circular frangible section 71 to rupture (at least partly) and allowing for the total release of said plug 70 along with the cap 50 from said base 1. An example of said force member arrangement will be discussed below.

The circular frangible section 71 here contains two semi-circular parts each oriented at a slope with respect to a plane normal to the twist axis, so that said semi-circular parts (in side view) generally have the shape of a V. The FIG. 3 cross section reveals an uppermost point of the section where the reference numeral 71 is placed, and a lowermost point of the frangible section along the other cross-sectional shown side. It is noted that an inverted V arrangement is likewise possible.

As is preferred the cap 50 includes one or more force members adapted to engage directly on each sloping oriented part of the frangible section 71, thereby each effecting rupture of at least a part of the frangible section 71.

In this example said force members are constituted by an annular wall 61 of the cap 50 depending downward from the top wall 51 at a location spaced inward from the skirt 52. The wall 61 here has a lower edge having a shape complementary to the V-shape of the frangible section 71, or at least including lower parts extending downwards till “between” the V-shaped parts of the frangible section 71. It is noted that in this example the lower edge of the wall 61 is designed as a cutting edge by forming a sharp edge thereon.

In conjunction with the ramp arrangements 15 the effect of twisting open the cap 50 from its closed position is that the lower edge of annular wall 61 comes to bear at two diametrically opposed locations against the circular frangible section 71, namely the upward sloping parts of said section 71. By twisting the cap 50 open even further, the non-sloping ramp sections 15a cause the cap 50 to perform a “pure rotation”. In fact the upper ribs 16b prevent the lugs 58 and thus the cap 50 from moving upwards, which makes the lower edge of the wall 61 or parts projecting therefrom to be forced through the associated parts of the section 71 which then rupture, in this example over about a 90 degree stretch at diametrically opposed locations.

The skilled person will thereby understand that for this effect to be caused the “non-sloping ramp sections” will have an angle or inclination less than the angle or inclination of the sloping sections of the frangible section 71. This is preferably achieved by the non-sloping ramp sections extending in a plane normal to the twist axis. It can also be envisaged that the non-sloping ramp sections have a negative, angle with respect to a plane normal to the twist axis, so that upon rotation of the cap the force members also move somewhat “downwards’ into the tubular part. This could promote the rupturing of the frangible section. However a rotation in said normal plane or at a slight positive angle (less than of the sloping parts of the frangible section) is preferred.

Upon further opening the cap 50 the lugs 58 enter the sloping “lift and rotate” sections of the ramp structure, so that now the cap 50 is lifted away from the tubular part 2 while being rotated. Depending on the design of the section 71 in combination with the design of the ramp arrangements 15 (in particular the slope of the one relative to the slope of the other) some further cutting action of the lower edge of the wall 61 through the section 71 might be caused, while also the effect that the plug 70 is lifted upwards as it is connected to the cap 50 causes a tearing of the yet unruptured parts of the circular section 71. This tearing takes little effort as parts of the frangible section have been ruptured already by the action of the force members.

As follows from the above it is envisaged that the action of the force members while the lugs 58 pass through the non-sloping section of the ramp structure does not lead to a complete rupture of the circular frangible sections, so that parts of said frangible section remain intact. The plug-cap connector members are designed however to provide a retaining force which is sufficient to cause said non-ruptured parts of the frangible section to be torn as the lugs pass through the “lift and rotate’ sections of the ramp structure.

In addition to, or possibly as alternative for, the one or more force members acting directly on the frangible section 71, the cap 50 can be provided with one or more centrally arranged force members acting on a central part of the plug 70, remote from the frangible section 71.

As can be seen in the FIGS. 1, 3 the plug 70 here, as is preferred, includes an annular wall 75 coaxial with the tubular part 2 and forming a space with the interior side of the tubular part 2. The one or more force members acting directly on the section 70, here the wall 61, protrude into said space. This prevents these force members from moving sideways thereby diminishing or rendering ineffective their action forcing the rupture of the section 70.

The annular wall 75 here is a raised wall with respect to a recessed central region of the plug 70, which is bounded by said wall 75.

Here the central region of the plug 70 includes sloping oriented upper surfaces 78 corresponding to the sloping parts of the frangible section 70. So when seen in cross-section the central region of the plug 70 here has a V-shaped upper surface, basically formed by two semi-circular faces arranged at an angle with a normal plane to the twist axis of the assembly.

In the drawings shown here the surfaces 78 are visible in FIG. 3.

Depending from the top wall of the cap 50 there could be arranged (not in this embodiment) one or more centrally arranged force members, their lower ends arranged just above or in contact with the surface 78 and preferably having a complementary shape. For example such force members could be embodied as ribs, e.g. in the shape of a cross, depending from said top wall 51.

Upon twisting the cap 50 from its closed position the central force members could cause a downward force to be exerted on the plug 70, assisting in, or causing, the rupture of the frangible section 71. Preferably said force members 65 could extend next to the annular wall 75, exerting pressure close to the section 71 and potentially supporting said wall 75 against bending inwards under the influence of the other force members 61.

As can be seen in the drawings the plug 70 here includes the annular wall 75 and an essentially V-shaped disc member 79, its outer perimeter integral with said interior surface of the tubular part via said frangible section 71. It is noted that here the annular wall is “extended till below” said disc member 79 in order to obtain increased rigidity of the plug 70.

As is preferred the annular wall 61 also acts as an annular sealing wall of the cap 50, the annular wall 61 and the interior side of the tubular part 2 having mating circumferential sealing surfaces (at 63) sealingly engaging one another in the closed position of the cap 50. This provides a sealing of the channel 50 in addition to the plug 70 as the cap has not been opened yet, but also allows for reclosing of the assembly. Preferably said mating sealing surfaces are provided close to the mouth of the tubular part 2.

As can be seen in the FIGS. 1, 3, 4 the plug 70 here also includes a central raised pillar 76, extending upward in the centre of the plug 70 and lying against the underside of the top wall 51 in the closed position of the cap 50. This contributes to the stability of the plug 70 in the closed position of the cap.

As is preferred the skirt 52 of the cap 50 near the lower edge thereof includes a circumferential sealing surface 52d (see FIG. 3) mating in the closed position of the cap with an associated circumferential sealing surface on the base, e.g. a circumferentially extending rib arranged on the tubular part (here rib 8). In this manner the area between the skirt and the tubular part 2 is also closed from the outer atmosphere. Rib 8 here also serves to retain the band 55 upon opening the closure assembly.

As can be seen in the drawings the circular frangible section 71 here has a tapering thickness so that a minimum thickness is present adjacent said interior side of the tubular part 2. This promotes the rupture of the section immediately adjacent or even flush with the interior surface, so that no or hardly any disturbance of the flow of substance is caused at this location when the substance is flowing through the channel.

A further topic to be discussed here is the plug-cap connector means.

As can be seen in FIG. 3 the annular wall 75 here is provided with a lightly ribbed outer surface, engaging on an also ribbed inner surface of the wall 61. This creates a frictional fit between the cap 50 and the plug 70, which could also be reached with other frictional fit arrangements.

In an alternative embodiment not shown the wall 75 is is provided at its upper end with a hook member, e.g. a circumferential rib projecting outwardly, engaging behind (here above) a hook surface provided by the annular wall 61. The arrangement could be such that the cap 50 can be snapped onto said annular wall 75 as the cap is fitted on the tubular part 2. In the closed position of the cap an “axial” play is preferably present between said hook member on the plug and the lower lying hook surface of the cap.

The “frictional fit arrangement” or the above mentioned alternative both provide for allowance of a downward motion of the plug 70 with respect to the cap 50 and the tubular member 2 as the plug is forced in said direction by the action of the force members acting thereon. It is noted that the plug is then still retained by the cap 50 within this range of play.

As mentioned before the bayonet connector members allow the cap 50 to be snapped to its closed position on the tubular part 2 by a rectilinear motion without rotation. In order to effect this in an automated assembly device, as is preferred for mass production, both the cap 50 and the base are provided with a positioning member or shaped so as to be placed in a particular orientation, e.g. in or on a base handling part and a cap handling part of an automated assembly device. The automated assembly device then can effect a rectilinear movement of said cap handling device relative to said base handling device.

Here the cap 50 is provided with a raised positioning rib 80, here both on the top and at the side of the skirt.

In a preferred embodiment upon placing the cap 50 onto the tubular part 2 provision is made for an internal support, supporting the plug 70 at the side opposite the cap 50 in order to prevent excessive force onto the frangible section or even undesired rupture of said frangible section 71. Said internal support can obviously be integrated into the automated assembly device mentioned above.

As is shown in FIGS. 1-4 the base here is made with a part that allows fitment between the walls of a pouch, e.g. flexible (multi-layer) film walls, e.g. by a (heat)sealing technique.

FIGS. 5-9 show a second preferred embodiment of the twist cap closure assembly wherein similar parts have been denoted with the same reference numerals.

A difference with the embodiment of FIGS. 1-4 is that the base now includes a container part which allows the base to be fitted to a container, in particular a (planar) panel of a container, e.g. a pouch having an opening in a wall thereof, or a carton, etc. The flange could e.g. be fitted on the inner side of a panel of a container (e.g. a gable top container) wherein the tubular part extends outward through an opening in said panel.

Also it can now be seen that the cap is provided with a further downward depending wall 62, spaced inwards of the wall 61 and the wall 75. The wall 75 here is provided at its upper end with a hook member 75a, here a circumferential rib projecting inwardly, engaging behind (here above) a hook surface provided by the inner annular wall 62. The arrangement could be such that the cap 50 can be snapped onto said annular wall 75 as the cap is fitted on the tubular part 2. In the closed position of the cap an “axial” play is present between said hook member on the plug and the lower lying hook surface of the cap.

Referring to FIGS. 10-12 a detail of a preferred embodiment of the twist cap closure assembly will be discussed. These figures show a part of a cap 100 and of a plug 90 which can be incorporated into the twist cap closure assembly.

The plug 90 is shown here with the frangible section 91 extending around its outer perimeter. This frangible section 91 includes four sloping parts 91a and four intermediate parts 91b, each part 91b being arranged between consecutive sloping parts 91a.

Of the cap 100 here only an annular wall 101 (similar to wall 61) and top wall 102 are shown. The skirt has been left out for clarity reasons.

The cap 100 is designed to open when twisting anti-clockwise (as is common). The cap 100 includes a number of force members 105,106,107,108, (here arranged at the lower end of an annular wall 101) equal to the number of sloping parts 91a. These force members 105-108 are arranged and adapted to engage directly on the frangible section 91, each on an associated part 91a thereof.

The force members 105-108 can have a “blunt” side which engages the frangible section, said, blunt side could be arranged parallel to the twist axis. Other shapes of said side, including a “knife” version are also possible.

The sloping parts 91a and the force members 105-108 (at least the effective parts thereof) are here, as is preferred, distributed in angular direction in such manner that—when twisting open the cap 100—the force members 105-108 sequentially come into contact with the corresponding sloping part 91a. The effect caused hereby is a reduction of the torque needed to twist open the cap 100. If all first contacts between force member and sloping part were to occur at the same time a greater torque is needed than with a sequentially occurrence of the first contact.

In a possible embodiment the frangible section has a non-uniform thickness along its circular extension. For instance it can be envisaged that the frangible section has a reduced thickness at each location where a force members first engages the frangible section to enhance the first rupture of the section at said locations.

It is noted that for reason of clarity the FIGS. 10-12 do not shown plug-cap connection means either.

This example also shows an optional central projection 92 on the plug 90, just as pillar 76. This projection, which could also have the shape of a central pillar, is provided for the injection moulding of the base with plug. Preferably a flow of molten plastic forming the plug is injection via said central projection so that the frangible section is formed by molten plastic flowing radially outward from the plug to the surrounding tubular part 2.

As explained the cap-plug connector members may be formed based on a friction fit, as alternative to form-fit arrangements like snap-fit, between said connector members on the cap and the plug respectively, e.g. an annular wall on the cap frictionally engaging an annular wall on the plug, possibly with the provision of friction enhancing ribs and/or grooves on one or both annular walls in the region of frictional contact.

It is noted that in a variant of the closure assembly the skirt of the cap is provided with one or more ramp structures and the lug(s) or follower(s) are provided on the tubular part. This allows for a more “smooth” appearance of the tubular part, e.g. when it is desired to drink directly from said tubular part. For a small diameter tubular part (and thus skirt of the cap) one could envisage to mould the cap in two (interconnected) halves which are then assembled (e.g. welded) into a cap.

As will be apparent to the skilled person the base of the twist cap closure assembly does not have to be adapted to be fitted directly onto a container. One or more further parts could be positioned between the base on the container to obtain the fastening of the base onto the container. For instance the base which is integral with the plug could be an annular member (e.g. an extension of the tubular part) which allows the base to be snap-fitted or otherwise fastened onto a further member, e.g. a support fitment which has been fitted on the container. This would e.g. allow to fill the container with the closure assembly removed, so that filling can take place through the support fitment and then the closure assembly can be installed.

The cap 50 can have all sort of designs. The cap 50 could also be provided with an overcap, preferably by press-fit, e.g. for decorative or other reasons (e.g. choke hazard prevention, increase grip for elderly, etc)

1. A twist cap closure assembly comprising:
a moulded thermoplastic base including a tubular part, which has an interior side defining a channel in said tubular part and also has an exterior side, said tubular part forming a mouth of said channel at one end thereof,
a moulded thermoplastic twist cap adapted to be fitted on said tubular part of said base so as to close off the mouth in a closed position of said cap, said cap including a top wall and a downward annular skirt depending from said top wall, said skirt having an interior side, an exterior side and a lower edge,
said exterior side of said tubular part and said interior side of said skirt having mating bayonet connector members having a twist axis,
said bayonet connector members being adapted to hold said cap in its closed position on said tubular part and allow for the cap to be twisted about the twist axis to release said cap from the base so that the channel is opened,
wherein a plug is arranged within said channel in said tubular part of the base, said plug being moulded integrally with said base and forming a hermetic closure of said channel, said plug being integrally connected to said interior side of the tubular part at a location spaced from said mouth and via a circular frangible section formed by moulding said base with integral plug,
said plug and said cap including integrally moulded mating plug cap connector members, said plug-cap connector members being adapted to cause said plug to be connected to said cap in the course of first-time fitting of said cap on said tubular part in its closed position,
said plug-cap connector members forming a rotary connection allowing for rotation of said cap with respect to the plug when the cap is twisted from its closed position to release the cap from the base,
said plug-cap connector members furthermore being adapted to retain said plug in said cap when said cap is twisted and released from the base,
said cap further including one or more force members depending from said top wall so as to extent towards the plug when the cap has been fitted in its closed position, said one or more force members engaging on said plug upon twisting open said cap, said force members thereby exerting a force on said plug causing said circular frangible section to rupture allowing the release of said plug along with the cap from said base.

2. Closure assembly according to claim 1, wherein at least a part of said circular frangible section is oriented at a slope with respect to a plane normal to the twist axis, and wherein a force member of said cap has an engagement face located and adapted to engage on said sloping part of said frangible section, said bayonet connector members being adapted so that upon twisting the cap from its closed position said force member is forced against said sloping part of the frangible section causing the frangible section to rupture.

3. Closure assembly according to claim 2, wherein said circular frangible section contains multiple sloping parts distributed around said frangible section, and wherein said cap comprises an equal number of force members, each force member being arranged to engage on an associated sloping part.

4. Closure assembly according to claim 3, wherein said sloping parts and force members are distributed in angular direction such that—upon twisting open said cap from its closed position—said force members sequentially start to engage on the associated sloping part.

5. Closure assembly according to claim 3, wherein said frangible section contains two semi-circular parts each oriented at a slope with respect to a plane normal to the twist axis, said semi-circular parts generally being arranged in the shape of a V or inverted V in elevational view, or wherein said frangible section contains four sloping parts each oriented at a slope with respect to a plane normal to the twist axis, a further part of said frangible section being present between neighbouring sloping parts.

6. Closure assembly according to claim 1, wherein said bayonet connector members include a ramp structure having one or more ramps arranged on the exterior side of the tubular part and wherein the bayonet connector members include one or more lugs arranged on the interior side of the skirt and cooperating with said one or more ramps.

7. Closure assembly according to claim 6, wherein the exterior of the tubular part defines a rest location for a lug in the closed position of the cap, and wherein adjoining said rest location for the lug the ramp structure defines an essentially non-sloping section followed by a sloping lift section, so that upon twisting said cap from its closed position, said cap first performs an essentially rotary motion about said tubular part as the lug follows the non-sloping section of the ramp structure, followed by a combined rotary and lift motion wherein the cap both rotates and is lifted with respect to the tubular part.

8. Closure assembly according to claim 6, wherein said cap is twistable over essentially half a turn, and wherein the ramp structure is composed of two diametrically arranged ramps on said tubular part.

9. Closure assembly according to claim 7, wherein the non-sloping section extends essentially about a quarter turn around the tubular part.

10. Closure assembly according to claim 1, wherein the cap includes an annular sealing wall depending downward from the top wall and spaced inward of the skirt, the sealing wall and the interior side of the tubular part having mating circumferential sealing surfaces sealingly engaging one another in the closed position of the cap.

11. Closure assembly according to claim 1, wherein the skirt of the cap near the lower edge thereof includes a circumferential sealing surface mating in the closed position of the cap with an associated circumferential sealing surface on the base.

12. (canceled)

13. Closure assembly according to claim 1, wherein the plug includes an annular wall coaxial with the inside of the tubular part and spaced therefrom, thereby forming a space with the interior side of the tubular part, said one or more force members of the cap protruding into said space.

14. Closure assembly according to claim 2, wherein—facing the top wall of the cap—said plug includes—within the contour of the circular frangible section—one or more sloping oriented upper surfaces corresponding to the one or more sloping parts of the frangible section.

15. (canceled)

16. Closure assembly according to claim 14, wherein one or more force members of the cap are arranged and adapted to engage on an associated sloping oriented upper surface of the plug.

17. Closure assembly according to claim 1, wherein said plug includes an essentially V-shaped disc member, the outer perimeter of said disc member being integral with said tubular part via said circular frangible section.

18. Closure assembly according to claim 1, wherein the circular frangible section has an outwardly tapering thickness such that a minimum thickness is present adjacent said interior side of the tubular part.

19. Closure assembly according to claim 1, wherein the one or more force members are arranged and adapted to engage on said circular frangible section and include a cutting face which cuts through the frangible section upon twisting open of the cap.

20. Closure assembly according to claim 1, wherein the plug-cap connector means are adapted as snap connector means.

21. Closure assembly according to claim 1, wherein the bayonet connector members allow the cap to be snap-fitted on the tubular part and into its closed position by linear motion without rotation.

22. (canceled)

23. (canceled)

24. Closure assembly according to claim 1, wherein the tubular part includes a stop rib defining the rest location of a lug on the skirt of the cap in the closed position of the cap.

25. (canceled)

26. Closure assembly according to claim 1, wherein the plug-cap connector means allow for a defined play between the plug and the cap in the direction of the twist axis, so that the plug upon rotation of the cap can essentially be forced deeper into the channel by engagement of the one or more force members of the cap on the plug, the cap still being retained by the cap within the range of play.

27. Closure assembly according to claim 1, wherein the base includes a container part which allows the base to be fitted to a container.

28. (canceled)

29. (canceled)

30. (canceled)

31. A container provided with a twist cap closure assembly according to claim 1.

32. Method for manufacturing a twist cap closure assembly according to claim 1, comprising moulding the base with integral plug, moulding the cap, and fitting the cap on the tubular part of the base.

33. Method according to claim 32, wherein the cap is adapted to be snap fitted on said tubular part, the plug-cap connector members also being adapted to be snap fitted, wherein the method includes effecting an essentially rectilinear motion of the cap with respect to the base so that said cap is snap fitted on the base.

34. (canceled)
